(19) United States
(12) Patent Application Publication
(10) Pub. No.: US 2012/0166531 A1
(43) Pub. Date: Jun. 28, 2012

(54) LOCATION SHARING SESSION

(76) Inventor: Dany Sylvain, Gatineau (CA)

(21) Appl. No.: 12/977,799

(22) Filed: Dec. 23, 2010

(51) Int. Cl. G06F 15/16

(52) U.S. Cl. 709/204

(57) ABSTRACT

Methods, systems, and computer readable media for providing location sharing sessions are disclosed. One method includes receiving signaling from a first endpoint for establishing a location sharing session. The method also includes signaling at least one second endpoint for establishing the location sharing session and receiving signaling from the at least one second endpoint accepting the establishment of the location sharing session. The method also includes, in response to receiving the signaling from the at least one second endpoint, establishing the location sharing session between the first and the at least one second endpoint such that the first and at least one second endpoint shares location media directly using the location sharing session.

### TECHNICAL FIELD

The subject matter described herein relates to location sharing in a communications network. More specifically, the subject matter disclosed herein relates to location sharing between one or more endpoints on an ad hoc basis over a signaling session in an efficient and effective manner.

### BACKGROUND

There are many instances where sharing location information can be useful. For example, such instances can include, without limitation, geotagging various media, friends navigating their way to find each other for a meeting, and potential patrons wishing to locate a particular business. Sharing location information is typically accompanied by privacy concerns among users who desire location information to remain hidden and/or inaccessible to unwanted third parties. Conventional attempts to share location information include using location sharing applications or encapsulating location data within a presence based system, for example, defining location as an object according to RFC 4119, which is incorporated by reference herein in its entirety.

While conventional location sharing systems can transmit location information between users and user equipment, such systems are subject to limitations requiring advanced preparation and/or requirements that must be met prior to sharing location information. Such systems cannot share location on a dynamic or ad hoc basis. For example, sharing location using a specific user/web application requires each user to purchase and/or download a distinct application prior to retrieving location data. Likewise, sharing location in a presence based system requires users to subscribe to another's presence using a “contact” Uniform Resource Identifier (URI). A presence-based system requires authentication and/or specialty decryption of location information prior to retrieving location information. In addition, the contact URI may not be present, thus, access to location data would be blocked. Also, presence-based systems fail to allow users to share location data on a temporary basis. Thus, to date, there is not an easy and/or effective mechanism by which users can share location data directly, and without advanced planning or preparation.

Accordingly, in light of these difficulties, a need exists for improved methods, systems, and computer readable media for facilitating location sharing using an ad hoc, or dynamic, private signaling session.

### SUMMARY

Methods, systems, and computer readable media for facilitating location sharing sessions are disclosed. One method includes, at a service node, receiving signaling from a first endpoint for establishing a location sharing session. The method further includes signaling at least one second endpoint for establishing the location sharing session and receiving signaling from the at least one second endpoint accepting the establishment of the location sharing session. The method further includes, in response to receiving the signaling from the at least one second endpoint, establishing the location sharing session between the first and the at least one second endpoint such that the first and at least one second endpoint share location media directly using the location sharing session in a manner that bypasses the service node.

A system for facilitating location sharing sessions is also disclosed. The system includes a service node having an interface for receiving signaling from a first endpoint and receiving signaling from at least one second endpoint for establishing the location sharing session. The system further includes a location session establishment module for, in response to receiving signaling from the at least one second endpoint accepting the establishment of the location sharing session, establishing the location sharing session between the first and at least one second endpoint over which location media can be shared directly using the location sharing session.

The subject matter described herein may be implemented in hardware in combination with software and/or firmware. As such, the terms “function” or “module” as used herein refer to hardware in combination with software and/or firmware. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, the term “endpoint” refers to a point of termination for a communications session including a location sharing session. An endpoint can be a landline telephone, a SIP phone, a mobile phone (cellular or otherwise), a VoIP phone; a personal computer, a smartphone, or any combination thereof.

As used herein, the term “node” refers to a physical device capable of communicating with other devices over a network. A node may include a computing platform with one or more processors, memory, and one or more network interfaces.

### BRIEF DESCRIPTION OF THE DRAWINGS

The subject matter described herein will now be explained with reference to the accompanying drawings of which:

FIG. 1 is a network diagram illustrating an exemplary communication environment according to an embodiment of the present subject matter described herein;

FIG. 2 is a network diagram illustrating a communication environment according a second embodiment of the present subject matter described herein;

FIG. 3 is a network diagram illustrating a communication environment according to yet another embodiment of the present subject matter described herein;

FIG. 4 is a message flow diagram illustrating a location sharing session and delivery of location information according to an embodiment of the subject matter described herein;

FIGS. 5A to 5C illustrate a location sharing session via screen shots of user equipment (UE) according to an embodiment of the subject matter described herein;

FIG. 6 is flow chart illustrating an exemplary process for establishing a location sharing session according to an embodiment of the subject matter described herein; and

FIG. 7 is a block diagram illustrating a service node according to an embodiment of the present subject matter.

### DETAILED DESCRIPTION

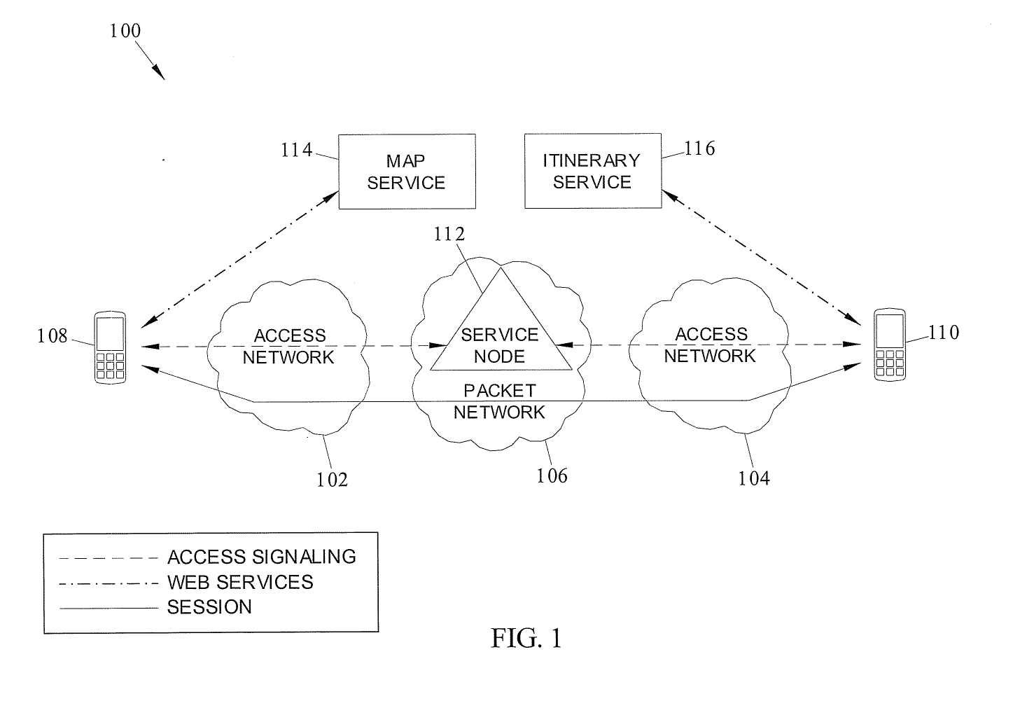

The subject matter described herein includes methods, systems, and computer readable media for facilitating and/or establishing a location sharing session between endpoints. FIG. 1 is a network diagram illustrating an exemplary network, generally designated 100 including a location sharing system according to an embodiment of the subject matter described herein. Referring to FIG. 1, network 100 includes first and second access networks 102 and 104, respectively, and a packet network (also referred herein as a mobile network or a mobile packet core network) 106. In the embodiment shown in FIG. 1, access networks 102 and 104 may be any type of broadband network such as DSL, WiFi, WiMax, UMTS, LTE, providing data connectivity to various types of user equipment (UE), such as, wireless phones UE 108 and UE 110. A UE can be any device capable of receiving or sending communications using network 100. For example, UE 108 may include a mobile phone, a computer, a tablet computer, a smartphone, a pager, or other device. In one embodiment. UE 108 and UE 110 can communicate wirelessly using respective access networks 102 and 104 via radio access nodes (not shown). UE 108 and UE 110 can access packet network 106 from respective access networks 102 and 104 and can establish a media session using at least one service node 112, e.g., a SIP proxy server, an application server, or an IMS node. Service node 106 may be capable of originating and/or terminating location sharing sessions between UE 108 and UE 110 using SIP signaling technology. While SIP can be used to effect origination, termination, and transfer of a location sharing session as described herein, the subject matter described herein is not limited to using SIP. Any suitable protocol for establishing media sessions between endpoints can be used without departing from the scope of the subject matter described herein.

Still referring to FIG. 1, either of UE 108 and UE 110 can originate and/or terminate a location sharing session using, for example, via SIP signaling communicated over respective access networks 102 and 104 to packet network 106 and service node 106, as illustrated by the uniform dashed line. In one aspect, UE 108 can initiate a location sharing session using signaling across first access network 102, which is received at service node 112 residing in packet network 106. UE 108 and UE 110 can transmit signals, for example, signifying acceptance or rejection of an invitation to join a location sharing session or any media session at service node 112. Once UE 108 and UE 110 acknowledge the session and type of media to be shared, the media session can be established. A location sharing session can be established directly between UE 108 and UE 110 or, in the alternative, location media may be shared as an option for another type of media session. Notably, location sharing sessions according to the disclosure herein can be established on an ad hoc basis using standard SIP signaling, without users having to fulfill any prerequisites. A location sharing session may be a special purpose session for exchanging location media and may be distinct from (without requiring) a voice call. Alternatively, a location sharing session may be set up as a sub-session to a voice call using the same setup messages used to establish the voice call, but providing for the exchange of location media separately from voice communications during the voice call.

Location media may include location data for one or more endpoints, for example location data for UEs 108 and 110. Location data can include geographic address data or geographic coordinates, e.g., latitude and/or longitude data. Location data can be generated using resources provided by entities separate from UEs 108 and 110, such as a cellular location service (LCS). In another example, location data can be generated using global positioning system (GPS) hardware and/or software local to UEs 108 and 110. Location data can also be generated or derived using serving radio tower location, serving cell or sector location, Wi-Fi service set identifier (SSID), or any other mechanism from which subscriber location information can be derived. In one embodiment, one endpoint may originate a session with an LCS server, obtain location data, and relay the data to another endpoint via a location sharing session. Location data may also include timestamp data so that currency of the location data can be determined. Location data may include geographic data including geography markup language (GML) data encoded in extensible markup language (XML) and transported using MSRP. Location data in a session can be set up, or designated using options or attributes and the accuracy of the information can be as general or specific as desired. Location data can be in any suitable format, including text, graphical, and/or video format.

Location media can be shared between UEs 108 and 110. In one embodiment, location media can be shared directly between UE 108 and UE 110 as illustrated by the solid line representing traffic of location media sent during a location sharing session. Notably, the session can be established directly between UE 108 and UE 110, bypassing service node 112. For illustrative purposes, the solid line is shown as passing directly from UE 108 to UE 110. However, location media can be directed through one or more data networking nodes disposed between UE 108 and UE 110. Bypassing service node 112 allows location data passing between the respective parties to not be transiting via the service node and improve privacy. Thus, participants in a session and/or network carriers, for example, a carrier for packet network 106 may not need to provide extra security or privacy protection features, such as authentication or encryption, for a given location sharing session. However, the subject matter described herein is not limited to establishing a location sharing session without authentication or encryption. Establishing a location sharing session with authentication and/or encryption is intended to be within the scope of the subject matter described herein

Location sharing sessions can be established between and/or among multiple users or endpoints and may be a dynamic, ad hoc session between the endpoints. Sharing location media as disclosed herein can be treated as originating a conventional “call” (voice, text, or otherwise) transferring media among UE 108 and UE 110 using SIP signaling to set up the call. However, the parameters for the call may be tailored to the sharing of location media, rather than another type of call. SIP can be used to set up a standard message session relay protocol (MSRP) session which can transport location media between endpoints. Sessions can originate between existing contacts already residing in a device, or, in the alternative, first time contacts, such as a business found using a directory service, the phone's browser, or other source. Thus, prior planning, authentication, prerequisites, or downloading of distinct applications can be reduced. However, as will be described in more detail below, the subject matter described herein may include providing applications that reside on UEs 108 and 110 to provide enhanced location sharing services, such as map services and a user-friendly interface for establishing a location sharing session and sharing location media. SIP signaling between UE 108 and 110 can choose to participate in a location sharing session for sharing and retrieving location media by accepting a SIP invite, otherwise, the invite can be rejected. Location sharing sessions can be for any suitable duration. Sessions can be established between any endpoints and any number of endpoints capable of receiving a call.

Still referring to FIG. 1, once a session is established between UE 108 and UE 110, location media can be shared between UE 108 and UE 110 using the MSRP protocol defined in IETF RFC 4975, the entire contents of which are incorporated herein by reference. The location information carried by MSRP may take different forms, for example it may use the location format defined in RFC 4119. As described above, location media may include location data for one or both of endpoints UE 108 and UE 110. Users can independently opt or choose to share location media using respective devices. As set forth above, location media shared during a location sharing can be set up or designated using options or attributes in the signaling messages used to establish the location sharing session, and the accuracy of the location media can be as general or specific as desired. For example, location media may be accurate to 1 meter, 100 meters, 1 km, or as general as a city and/or state depending upon the application. As stated above, location media can be generated using GPS based functionality either integrated within each of UE 108 and UE 110 or the data can be communicated to each of UE 108 and UE 110 from respective access networks 102 and 104. Notably, as indicated by the solid line in FIG. 1, location media can be shared in a session directly between UE 108 and UE 110, or other devices, as will be described in more detail below, and can bypass service node 112 and packet network 106 to remain private.

Upon establishment of a location sharing session, UEs 108 and 110 can use the received location information to retrieve location media in various formats. For example, UEs 108 and 110 may retrieve one or more maps and/or text indicating a business address nearest to the location of UE 108 and 110. Location media retrieved by UEs 108 and 110 can optionally be generated and communicated using a map service 114 and/or an itinerary service 116. Map service 114 may generate a map showing the current location of the other party with the user's current location and present the combined location and map data to UEs 108 or 110. Itinerary service 116 may generate routing or driving directions between the current locations of UEs 108 and 110 or between either of the UEs and a specified point of interest. Itinerary service 116 may provide the routing or driving directions to UEs 108 or 110 for presentation to their respective users.

The interactions with the location media functions such as the map service 114 and itinerary service 116 can typically be implemented using hypertext transfer protocol (HTTP) transport invoking web services application programming interfaces (APIs). For example, UE 108 and/or UE 110 can use one or more APIs to retrieve a map showing UE 108 and 110 respective locations. The interactions to map service 114 and itinerary service 116 are illustrated by the “dot-dash-dot” (“•-•”) lines in FIG. 1.

Map service 114 and itinerary service 116 can be accessible together or individually as desired at each endpoint. For illustrative purposes, UE 108 is depicted as interfacing with map service 114, and UE 110 is depicted as interfacing with itinerary service 116. Map service 114 can transform the location media or data into a map retrievable at UE 108 and/or UE 110 to display location of each endpoint or only one endpoint on a map. Itinerary service 116 can transform the location media into a map retrievable at UE 108 and/or UE 110 to display location of both endpoints on a map and can further present routing instructions. For example, map service 114 can be used to determine the location of UE 108 and/or UE 110 and display one or both endpoints on a map. Itinerary service 116 can be used, for example, if UE 108 and UE 110 are trying to navigate their way towards each other. Itinerary service may generate and present routing instructions and/or a navigation route highlighted between the endpoints. In one embodiment, map service 114 can provide representation of a specific location (or set of locations) on a map. Itinerary service 116 can indicate on the map specific roads and/or routes to take to reach the location of the other party and/or endpoint. It should be noted that endpoints can be fixed. That is, an endpoint, such as a business or restaurant, may have a fixed location. Endpoints can also be mobile. For example, endpoints can be mobile users navigating their way around a city to find each other. Fixed endpoints, such as businesses, may set up terminals to which others can connect for establishing a location sharing session. The terminals at fixed endpoints may be configured to consistently share the same location information. For example, a restaurant may wish to automatically accept any invitation to join a location sharing session to enable patrons to navigate their way to the restaurant.

While using the HTTP protocol to interface with map service 114 and itinerary service 116 is described above, other protocols can be used to interface with map service 114 or itinerary service 116 without departing from the scope of the subject matter described herein. For example, communication with map service 114 or itinerary service 116 can occur using one or more of SIP, file transfer protocol (FTP), real time protocol (RTP), etc.

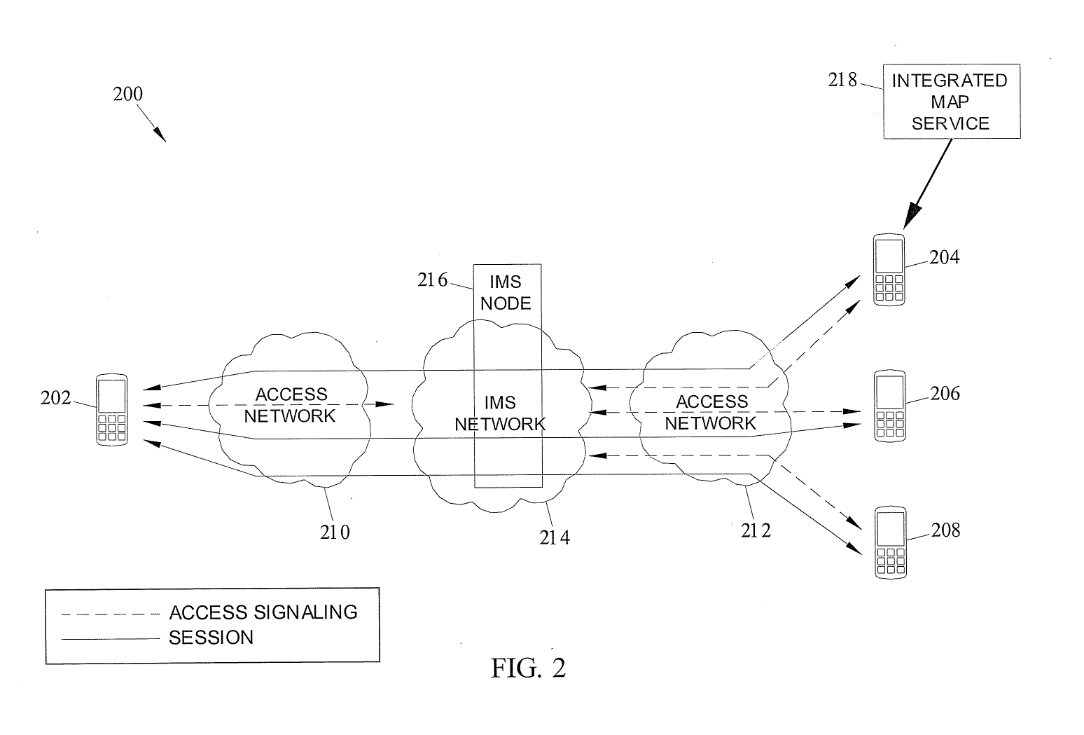

FIG. 2 is a network diagram illustrating a location sharing session established over an IMS network according to an embodiment of the subject matter described herein. In FIG. 2, a network, generally designated 200 includes a location sharing system according to an embodiment wherein location media can be shared between a plurality of endpoints, including UE 202, UE 204, UE 206 and UE 208. Network 200 can include first and second access networks 210 and 212, respectively, and an IP multimedia subsystem (IMS) packet network 214 (also referred to as IMS core). Network 200 including access networks 210 and 212 can be of similar form and/or function as described with respect to network 100 and access networks 102 and 104 illustrated in FIG. 1. In FIG. 2, the service node comprises an IMS node 216 within IMS core 214 and sessions can be facilitated through the IMS core 214 and between multiple endpoints by routing traffic based on header data to locate specific and/or private addresses of each endpoint. In one embodiment, location media, or data can be transported directly between endpoints so as to remain private. Service node 216 can be a call session control function (CSCF) or any suitable IMS node capable of signaling with endpoints to establish a location sharing session. For large deployments, more than one service node 216 may be deployed, each serving a subset of users. Service nodes 216 would communicate with each other to establish the location sharing session.

Location sharing sessions can be established using SIP signaling or any suitable protocol known now or in the future, through IMS core 214. Location media can be transported using MSRP or any other suitable approaches (e.g. SIP MESSAGE method). In FIG. 2, location sharing sessions are depicted by the solid lines. In one embodiment, session traffic can pass directly from UE 202 to one or more endpoints including each of UE 204, UE 206, and UE 208 and through IMS core 214. The session between UE 202 and each other endpoint can remain private, inaccessible to others, unless the endpoints invite others to join the session.

In FIG. 2, the origination of multiple location sharing sessions among multiple parties at a given time is also shown. Location sharing sessions can be temporary or permanent. For example, a location session between UE 202 and UE 206 can be an ad hoc, temporary session between at least two participants trying to navigate a route to each other and/or a meeting spot. The session between UE 202 and UE 204, however, may be a permanent session, originated on an ad hoc basis without prerequisites, for example, a session between a parent and a child, such that the parent can know the location of their child permanently, or for a given duration. The duration of a particular session can be specified using attributes, or parameters, which can be varied in an MSRP session set up using SIP, an example of which is provided below.

In FIG. 1, map service 114 and itinerary service 116 are illustrated as being separate from UEs 108 and 110. However, as FIG. 2 illustrates, in one embodiment, the map service may be an integrated map service 218 wherein the map service or function is integrated, or local, to the user or network device. Thus, UE 204 can transform location data by displaying the data in map form using its local integrated map service 218. Each of UE 204, UE 206, and/or UE 208 can include local integrated map service 218 or, in the alternative, access map service 114 and/or itinerary service 116 using web services interfaces as described with respect to FIG. 1.

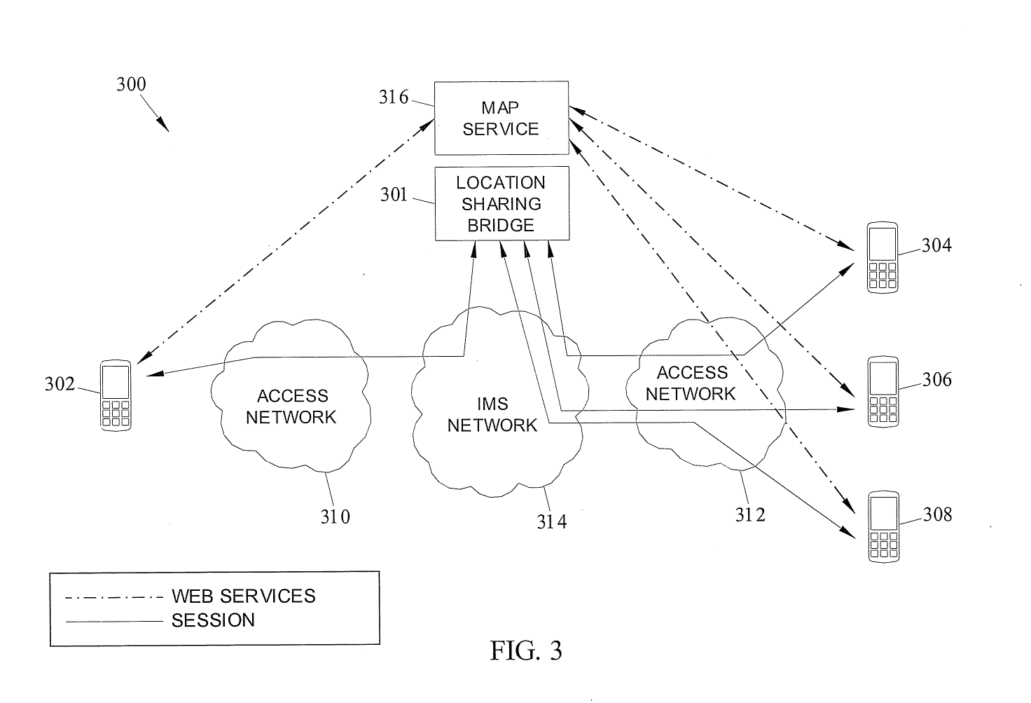

According to another aspect of the subject matter described herein, a location sharing bridge may be provided to facilitate location sharing sessions among more than two users. FIG. 3 illustrates an embodiment of the subject matter described herein that includes a location sharing bridge. In the example illustrated in FIG. 3, a location sharing session sharing can be a conference joining multiple endpoints into one session. A network, generally designated 300 includes a location sharing system according to an embodiment where location media can be collectively shared between a plurality of endpoints using, for example a location sharing bridge 301.

In FIG. 3, UEs 302-308 may participate in the conference-type location sharing session. Location sharing bridge 301 shares location media for each of the participants that participate in the conference session. That is, location media for each UE is shared among UEs 302-308. UEs 302-308 can establish individual location sharing sessions with the sharing bridge 301 via access networks 310 and 312. The signaling for establishing each leg of the conference session can be similar to the signaling described in detail below for establishing a location sharing session between two UEs. Once some or all of the individual legs of the location sharing conference have been established, location sharing bridge 301 may join the individual location sharing sessions to provide a conference-type location sharing session, which will allow the plurality of endpoints to share media with one another in conference fashion.

As FIG. 3 illustrates, network 300 can include various exemplary components, modules, and/or devices associated with at least first and second access networks 310 and 312, respectively, and IMS network 314 (also referred to as IMS core, IMS packet network, or IMS packet core network). Network 300, including networks 310 and 312, can be of similar form and/or function as the access networks described above with respect to FIGS. 1 and 2. Location sharing sessions can be established using SIP signaling through IMS core 314. In one embodiment, session traffic can pass directly from each of UE 302, UE 304, UE 306, and UE 308 through IMS core 314 to location sharing bridge 301. Location sharing bridge 301 may distribute shared location media of each endpoint 302-308 among endpoints 302-308.

Once location media, or data, is shared between the multiple participants in the location sharing session using location sharing bridge 301, the respective participants can individually access and/or interface with map service 316 using web services interfaces, designated as the dot-dash-dot line, and can display each of the parties on a map. This system allows multiple parties to share location media and display media for each participant on a map. For example, if each of the participants were trying to navigate to a restaurant or meeting place, map service 316 could produce a map having the restaurant and each participant on the map, and could optionally include routing instructions upon request using itinerary service (not shown) but as described in FIG. 1. Location updates sent by one endpoint can be propagated to all parties using a location sharing conference bridge 318.

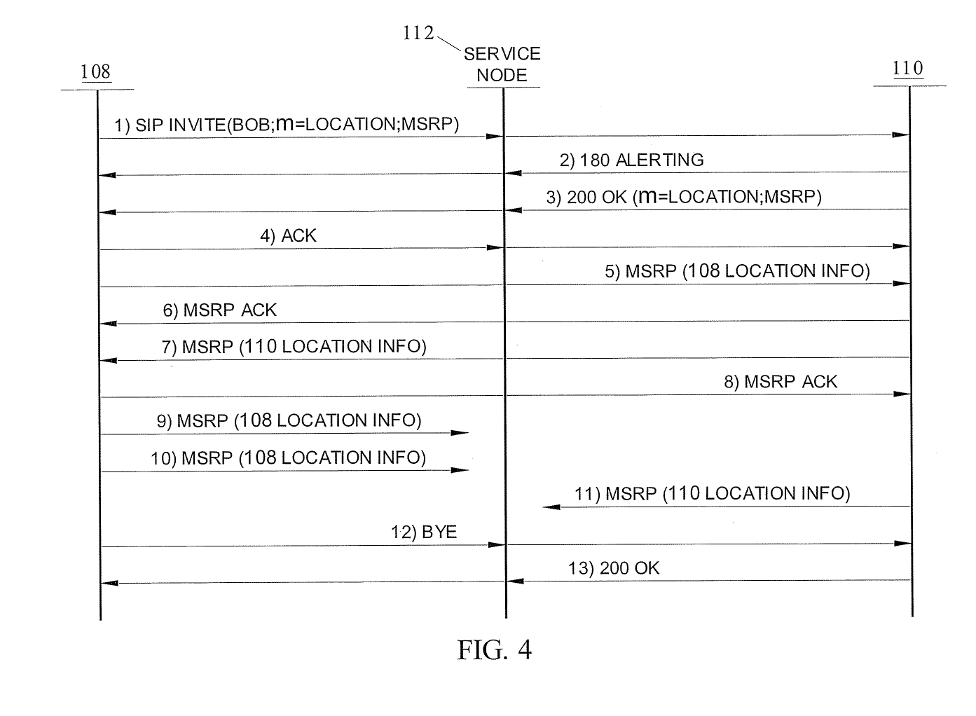

FIG. 4 is a message flow diagram illustrating exemplary messaging for establishing and exchanging location media using a location sharing session, for example, a session as illustrated in FIG. 1. Steps 1 to 4 illustrate SIP signaling used to establish a location sharing session. Location media can be transported directly between UE 108 and UE 110 in MSRP messages comprising various attributes. Location information can be shared directly between UE 108 and UE 110 in steps 5 to 11, which bypass service node 112.

Referring to step 1 of FIG. 4, UE 108 initiates a location sharing session with UE 110 by inviting UE 110 to participate in the location sharing session. Step 1 illustrates a SIP INVITE message sent to UE 100 with a media attribute (m) specified as LOCATION and using MSRP as transport. The media attribute identifies the session type as a location sharing session.

In step 2 of FIG. 4, UE 110 alerts and presents to its respective user an indication of the location sharing session initiation request from UE 108. UE 110 also generates and sends a 180 ALERTING message to UE 108 indicating the alerting of the user of UE 110. If participant UE 110 includes multiple devices, the INVITE could go through each device associated with the participant. In step 3, UE 110 accepts the request from UE 108 by sending a 200 OK message. In step 4, UE 108 acknowledges acceptance sending an ACK message. In a different embodiment, UE 108 can invite UE 110 directly via peer-to-peer sharing functionality, or implementation, if UE 108 can ring UE 110 directly at its endpoint address, e.g., network or IP address. The session can then be established directly between UE 108 and UE 110.

Location media is shared in steps 5 to 11. In step 5 the MSRP session is initiated to allow location data to be transmitted from UE 108 to UE 110. In step 6, UE 110 acknowledges the initiation of an MSRP session with an MSRP ACK message to UE 108. In step 7 and 8 the process is repeated for the reverse direction. In FIG. 4, the messages in steps 5 to 11 pass directly between UE 108 and UE 110 bypassing service node 112.

With the MSRP sessions established in both directions, the location data can now be shared between UE 108 and UE 110 as illustrated in steps 9 to 11. The sharing can be facilitated by specifying refresh attributes in the MSRP messages. UE 108 could send initial location media at step 9, and the media could be refreshed and resent at step 10 and beyond, according to the refresh attribute specified in the MSRP message format. In each of the steps location media can be refreshed at UE 110, for example on a map or in text format. Similarly, UE 110 sends initial location data using MSRP at step 11 and can send refreshed or updated data in subsequent messages (not shown). Once received, the location data can be displayed on UE 108 or 110 in the different methods described previously.

Location media can pass between UE 108 and UE 110 any number of times as specified in the MSRP attributes. In addition, multiple parties in addition to UE 108 and UE 110 can participate in multiple or a conference location sharing session as described above. Location sharing sessions can be terminated at the option of one of the participants. For example, UE 108 can terminate the session at step 12 by sending a BYE message to UE 110. UE 110 acknowledges the BYE message at step 13 with a 200 OK message, whereby the session is terminated. Another option is to set a duration attribute in the MSRP message whereby the session will be terminated after a certain amount of time if not terminated by one of the users. Although the location sharing session described above is bidirectional, the same overall approach can be used to establish unidirectional transfer of information data from one UE to another.

Examples of the messaging used in FIG. 4 are outlined below:

The messaging below corresponds to the message flow diagram of FIG. 4, with notable features or attributes designated by an asterisk (*). Note that the asterisk is for the purpose of description and is not part of the actual message.

### A. Example of SIP Invite at Step 1 of FIG. 4

INVITE sip:UE108@biloxi.example.com SIP/2.0
To: <sip:UE110@biloxi.example.com>
From: <sip:UE108@atlanta.example.com>;tag=786
Call-ID: 3413an89KU
Content-Type: application/sdp
c=IN IP4 atlanta.example.com
*m=location 7654 TCP/MSRP
a=accept-types:text/xml
*a=path:msrp://atlanta.example.com:7654/jshA7weztas;tcp
*a=duration: 1800
*a=refresh: 60
a=sendrecv

### B. Example of SIP 200 OK Message at Step 3 of FIG. 4

SIP/2.0 200 OK
To: <sip:UE110@biloxi.example.com>;tag=087js
From:<sip:UE108@atlanta.example.com>;tag=786Call-ID: 3413an89KU
Content-Type: application/sdp
c=IN IP4 biloxi.example.com
*m=location 12763 TCP/MSRP
a=accept-types:text/xml
*a=path:msrp://biloxi.example.com:12763/kjhd37s2s20w2a;tcp
*a=duration: 1800
*a=refresh: 60
a=sendrecv

### C. Example of ACK at Step 4 of FIG. 4

ACK sip:UE110@biloxi SIP/2.0
To: <sip:UE110@biloxi.example.com>;tag=087js
From: <sip:UE108@atlanta.example.com>;tag=786
Call-ID: 3413an89KU

D. Example of Sending MSRP Message with Location Data at Step 7 of FIG. 4

MSRP a786hjs2 SEND
To-Path: msrp://biloxi.example.com:12763/kjhd37s2s20w2a;tcp
From-Path: msrp://atlanta.example.com:7654/jshA7weztas;tcp
Message-ID: 87652491
Byte-Range: 1-766/766
Content-Type: text/xml
<?xml version=“1.0” encoding=“UTF-8”?>

<presence xmlns=“urn:ietf:params:xml:ns:pidf”
xmlns:gp=“urn:ietf:params:xml:ns:pidf:geopriv10”

xmlns:gml=“urn:opengis:specification:gml:schema-xsd:feature:v3.0”
entity=“pres:geotarget@example.com”>

<tuple id=“sg89ae”>
<status>

<gp:geopriv>

<gp:location-info>

<gml:location>

<gml:Point gml:id=“point1” srsName=“epsg:4326”>

*<gml:coordinates>37:46:30N122:25:10W</gml:coordinates>

</gml:Point>
</gml:location>

</gp:location-info>
<gp:usage-rules>
<gp:retransmission-allowed>no</gp:retransmission-allowed>
*<gp:retention-expiry>2010-06-23T04:57:29Z</gp:retention-expiry>

</gp:usage-rules>

</gp:geopriv>

/status>
<timestamp>2010-06-22T20:57:29Z</timestamp>
</tuple>
</presence>
-------a786hjs2$

### E. Example of MSRP ACK at Step 8 of FIG. 4

MSRP a786hjs2 200 OK
To-Path: msrp://atlanta.example.com:7654/jshA7weztas;tcp
From-Path: msrp://biloxi.example.com:12763/kjhd37s2s20w2a;tcp
-------a786hjs2$

Messaging examples (A) and (B) above are examples of SIP messaging specifying MSRP as the transport protocol for the session and media. New session description protocol (SDP) parameters are defined to describe the nature of the location media. For example, SDP may include accuracy, duration, session refresh cycle or frequency at which to receive updated location data. Message (A) is the invitation which can be accepted by UE 110 in message (B). The first asterisk of messages (A) and (B) denotes that m=location, thereby indicating location as a new type of media to be shared. Attributes are also designated by an (*) in messages (A) and (B) above. The path (a=path) of message (A) specifies the MSRP address of endpoint UE 108. The path of message (B) specifies the MSRP address of endpoint UE 110.

Duration can also be specified (a=duration) and is indicated as 1800 seconds in messages (A) and (B) above. The duration attribute can be set to an amount of time in which the session will terminate if not already terminated by one of the participants. If no duration is specified, then the session will terminate only when one of the parties terminates it. A refresh cycle attribute (a=refresh) can also be specified using an attribute in the SIP INVITE. In the above examples, location media can be refreshed or resent after 60 seconds. The refresh attribute can be set to refresh location data any time, distance, or location change desired. For example, a participant can specify a refresh time, or, in the alternative, may specify a refresh distance such as 2 blocks, 0.2 miles, or 2 kilometers. Refresh can also be triggered in response to a change in direction. For example location data can be refreshed when a participant changes directions, e.g., from north to south, east to west, etc.

The refresh attribute can be set to any suitable time, distance, and/or location change desired. Location media can be updated and/or resent as specified using this attribute for a suitable number of times.

Messaging example (C) above acknowledges the 200 OK message. Messaging example (D) indicates UE 108 sending or sharing location information using MSRP to UE 110. Location media, data, or information can be embedded using XML encoding. Message example (D) is an example of an MSRP message with location data encoded as per IETF RFC 4119. For example GML coordinates can be denoted by the (*) in this message. Other attributes or rules can be designated in the MSPR message, for example, a retention attribute can designate how long the location information is stored, that is, this attribute designates expiry time for location information. Messaging example (E) is an acknowledgement from UE 108 to UE 110 indicating that the MSRP message containing location data was received.

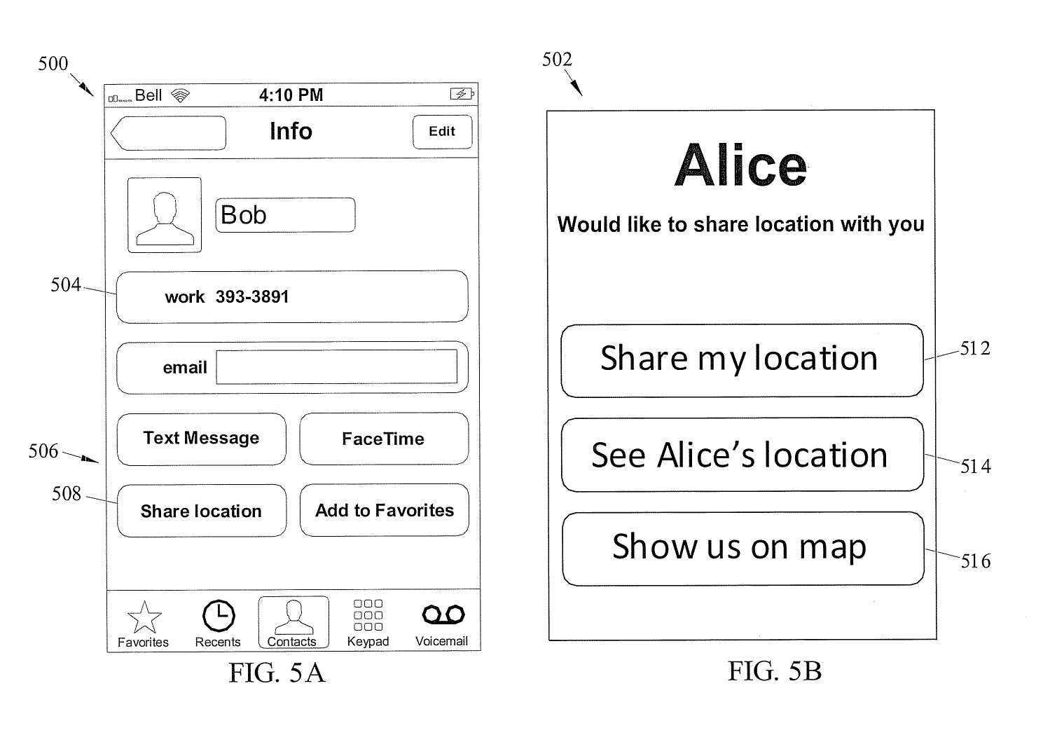

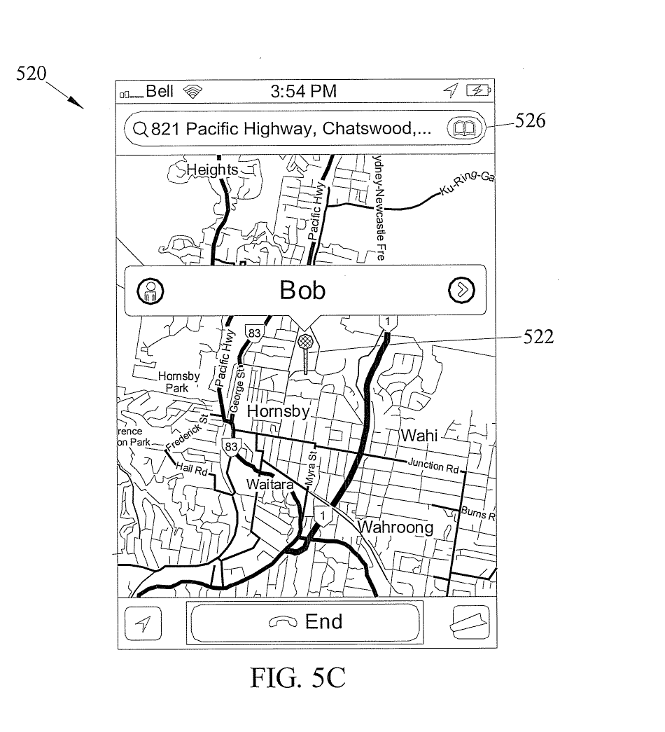

FIG. 5A to 5C illustrate examples of screen shots and options that may be presented to users of communications devices at each endpoint used in methods and systems for establishing and using location sharing sessions according to embodiments of the subject matter described herein. FIG. 5A illustrates a screen shot of smart phone interface 500 of an originating participant or session initiator. FIG. 5B illustrates a screen shot of smart phone interface 502 that may be presented to the recipient of an invitation to a location sharing session. Interfaces 500 and 502 may be presented by downloadable applications that execute on smart phones for providing location sharing sessions. Alternatively, interfaces 500 and 502 may be generated by a native telephony application on smart phones that has been updated to recognize the media sharing attributes set forth above.

In FIG. 5A, smart phone interface 500 displays contact information, such as a phone number 504, above one or more virtual buttons, generally designated 506. Virtual buttons 506 may trigger the sending of different types of media or the establishment of various types of sessions. For example, location sharing session button 508 initiates a location sharing session.

In FIG. 5B, interface 502 includes various buttons that are displayed to the invitee of a location sharing session. In the illustrated example, interface 502 includes buttons 512, 514, and 516. Button 512 allows the invitee to share his or her location with the invitor. Button 514 allows the invitee to view the invitor's location. Button 516 allows the invitee to view the location of both parties on a map.

FIG. 5C illustrates an exemplary map interface 520 that may be provided on a user device, such as UE 108 or 110, according to an embodiment of the subject matter described herein. In FIG. 5C, map interface 520 includes a virtual push pin 522 to indicate the current location of the user, Bob. Interface 520 also displays the street address 526 of Bob. In a location sharing session, interface 520 may also display the location of other parties to a location sharing session.

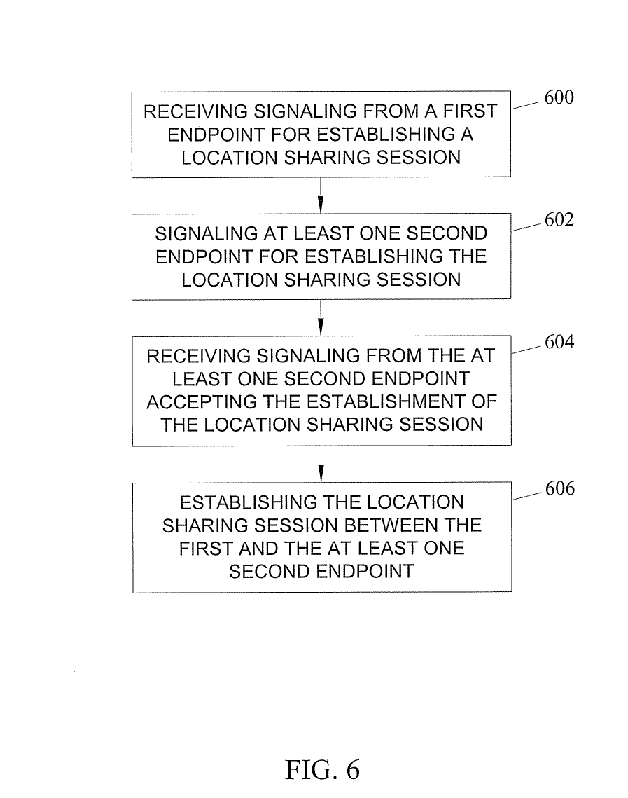

FIG. 6 is a flow chart illustrating an exemplary method for establishing a location sharing session according to an embodiment of the subject matter described herein. Referring to FIG. 6, in step 600, signaling is received from a first endpoint for establishing a location sharing session. For example, signaling may be received at a service node, which may be a SIP proxy or other type of network node for establishing a location sharing session. In step 602, at least one second endpoint is signaled for establishing a location sharing session. For example, the service node may signal a desired target of the location sharing session using SIP or other signaling to invite the target to participate in the location sharing session. In step 604, signaling is received from the at least one second endpoint for accepting the establishment of the location sharing session. For example, the service node may receive SIP signaling from the desired target of the location sharing session accepting the establishment of the location sharing session. In step 606, the location sharing session is established between the first and the at least one second endpoint. For example, the service node may establish, using the parameters specified in the signaling for the location sharing session, a direct, or private session between the endpoints. The endpoints can then use the location sharing session to directly share location information.

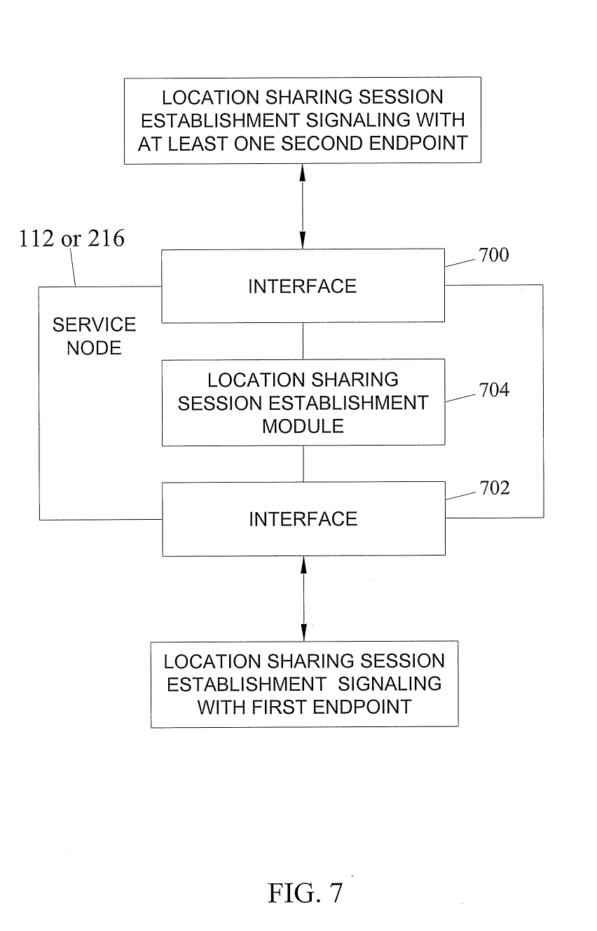

FIG. 7 is a block diagram illustrating an exemplary service node 112 or 216 for establishing a location sharing session according to an embodiment of the subject matter described herein. Referring to FIG. 7, service node 112 or 216 may be a SIP proxy, an IMS node, or any other suitable node for recognizing parameters associated with establishment of the location sharing session and signaling with endpoints for establishing the session. In FIG. 7, service node 112 or 216 includes interfaces 700 and 702 for interfacing with endpoints or nodes that interface with endpoints, such as radio access nodes. Interfaces 700 and 702 may be packet network interfaces capable of receiving IP packets that carry SIP or other payloads. Service node 112 or 216 may include a location sharing session establishment module 704 that performs the steps recited herein for establishing a location sharing session between endpoints. Location sharing session establishment module 704 may recognize signaling messages and attributes in the signaling messages for establishing a private location sharing session between endpoints. Service node 112 or 216 may be a physical device, such as a computing platform that includes at least one processor and associated memory.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for facilitating location sharing, the method comprising:
at a service node:
receiving signaling from a first endpoint for establishing a location sharing session;
signaling at least one second endpoint for establishing the location sharing session;
receiving signaling from the at least one second endpoint accepting the establishment of the location sharing session; and
in response to receiving the signaling from the at least one second endpoint, establishing the location sharing session between the first and the at least one second endpoint to allow the first and at least one second endpoint share location media directly using the location sharing session in a manner that bypasses the service node.

2. The method of claim 1 wherein signaling from the first endpoint for establishing the location sharing session includes specifying attributes in signaling messages to be transmitted to the at least one second endpoint that identify the session as a location sharing session and specify parameters of the location sharing session.

3. The method of claim 2 wherein the parameters of the location sharing session include at least one of: a duration of the location sharing session, accuracy of the location information shared during the location sharing session, indication if the location sharing session is send only, receive only or send-receive, and a location information update frequency for the location sharing session.

4. The method of claim 1 wherein the location sharing session is distinct from a voice call.

5. The method of claim 1 wherein the location sharing session is established using the same signaling used to establish a voice call and the location media is shared separately from voice communications during the voice call.

6. The method of claim 1 comprising providing applications configured to execute on the first and the at least one second endpoint for allowing users each of the first and at least one second endpoints invite other users to participate in the location sharing session.

7. The method of claim 6 wherein the applications are configured for presenting location information for the first and second endpoints on maps.

8. The method of claim 1 wherein the location sharing session comprises a message session relay protocol (MSRP) session.

9. The method of claim 1 comprising providing a map service for combining the location media with geographic map data.

10. The method of claim 9 wherein the map service is integrated with each of the first and the at least one second endpoints.

11. The method of claim 9 wherein the map service is separate from the first and the at least one second endpoints.

12. The method of claim 1 comprising providing an itinerary service configured to include route information in the location media.

13. The method according to claim 1 wherein establishing the location sharing session includes establishing the location sharing session between more than two endpoints.

14. The method of claim 1 wherein the service node comprises one of: a session initiation protocol (SIP) proxy and an IP multimedia subsystem (IMS) node.

15. A system for facilitating location sharing, the system comprising:
a service node including:
at least one network interface for exchanging signaling with endpoints; and
a location sharing session establishment module for:
receiving signaling from a first endpoint for establishing a location sharing session;
signaling at least one second endpoint for establishing the location sharing session;
receiving signaling from the at least one second endpoint accepting the establishment of the location sharing session; and
in response to receiving the signaling from the at least one second endpoint, establishing the location sharing session between the first and the at least one second endpoint to allow the first and at least one second endpoint share location media directly using the location sharing session in a manner that bypasses the service node

16. The system of claim 15 wherein the location sharing session establishment module is configured to include attributes in the signaling to the at least one second endpoint for identifying the session as a location sharing session and parameters of the location sharing session.

17. The system of claim 15 wherein the parameters of the location sharing session include at least one of a duration, a frequency at which location data in the location sharing session is updated, and accuracy of the location data.

18. The system of claim 15 wherein the location sharing session is distinct from a voice call.

19. The system of claim 15 wherein the location sharing session is established using the same signaling used to establish a voice call and the location media is shared separately from voice communications during the voice call.

20. The system of claim 15 comprising applications for executing on each of the first and the at least one second endpoints for establishing the location sharing session and sharing the location media.

21. The system of claim 20 wherein the applications are configured to present the location media to their respective users using maps.

22. The system of claim 15 wherein the location sharing session comprises a message session relay protocol (MSRP) session.

23. The system of claim 15 comprising a map service for combining the location media with geographic map data.

24. The system of claim 23 wherein the map service is integrated with each of the first and the at least one second endpoints.

25. The system of claim 23 wherein the map service is separate from the first and the at least one second endpoints.

26. The system of claim 15 comprising an itinerary service configured to include route information in the location media.

27. The system of claim 15 comprising a location sharing bridge for connecting more than two endpoints to the location sharing session.

28. The system according to claim 15 wherein the service node comprises one of: a session initiation protocol (SIP) proxy server and an IP multimedia subsystem (IMS) node.

29. A non-transitory computer readable medium having stored thereon computer executable instructions that when executed by a processor of a computer control the computer to perform steps comprising:
receiving signaling from a first endpoint for establishing a location sharing session;
signaling at least one second endpoint for establishing the location sharing session;
receiving signaling from the at least one second endpoint accepting the establishment of the location sharing session; and
in response to receiving the signaling from the at least one second endpoint, establishing the location sharing session between the first and the at least one second endpoint such that the first and at least one second endpoint share location media directly using the location sharing session in a manner that bypasses the service node.
